(19) United States
(12) Patent Application Publication
(10) Pub. No.: US 2017/0082503 A1
(43) Pub. Date: Mar. 23, 2017

(54) TEMPERATURE TAGS AND METHODS OF MAKING AND USING THE SAME

(71) Applicant: Empire Technology Development LLC, Wilmington, DE (US)

(72) Inventor: Yasuhisa Fujii, Kyoto (JP)

(21) Appl. No.: 14/862,041

(22) Filed: Sep. 22, 2015

(51) Int. Cl. G01K 7/36

(52) U.S. Cl. CPC G01K 7/36

(57) ABSTRACT

Temperature tags for determining if an object has been exposed to above certain temperatures are disclosed. The temperature tag includes one or more temperature sensitive regions on a substrate, wherein each of the one or more temperature sensitive regions comprise a temperature sensitive magnetic material having a Curie temperature. Methods of making and using the temperature tags are also disclosed.

### BACKGROUND

Goods that are sensitive to temperature changes, such as food items, require that their surrounding temperature be maintained within an acceptable range during transportation and handling. In the food industry, food items are usually shipped over long distances from farms or processing plants, to distribution centers, and then to their final destinations at restaurants or grocery stores. In many cases, the transportation may take several days and require that the food items be refrigerated or frozen. To maintain freshness and safety of the food items, it is important for the temperature be maintained within a safe range throughout the transportation. For perishable food items such as meats, fish and poultry, small temperature excursions of short duration outside the safe range can be undesirable.

Tracking systems such as Radio Frequency Identification (RFID) systems have been deployed with temperature sensing devices to detect temperature changes surrounding a product. The temperature sensing device is usually a negative temperature coefficient (NTC) thermistor. The NTC thermistor relies on the characteristics of certain ceramic materials whose electrical resistance change depending on the temperature. By passing an electric current through such a ceramic material, the NTC can measure changes in electrical resistance of the ceramic material resulting from exposure to temperature changes. Hence, the implementation of the RFID system typically require that the temperature sensing device have a continuous power source to detect the temperature change, which adds to the cost of implementation. In addition, some systems require that the temperature sensing device be connected to a comparator circuit, further adding to the cost of implementation.

Another device for detecting temperature changes surrounding a product can be in the form of heat-sensitive seals attached to the product. The heat sensitive seals can change colors at specific temperatures, which can be visually observed. However, there are problems associated with heat-sensitive seals, which usually include the lack of precision when measuring temperature changes, and a short lifespan (for example, less than a year).

Accordingly, there is a need for temperature tags that are capable of detecting temperature changes without the use of a continuous power source or additional circuitry. The temperatures tags may desirably be cost effective and can function over a prolonged period of time.

### SUMMARY

In some embodiments, a temperature tag includes one or more temperature sensitive regions on a substrate, wherein each of the one or more temperature sensitive regions include a temperature sensitive magnetic material having a Curie temperature.

In some embodiments, a method of making a temperature tag includes forming one or more temperature sensitive regions on a substrate, wherein each of the one or more temperature sensitive regions include a temperature sensitive magnetic material having a Curie temperature.

In some embodiments, a method of using a temperature tag includes: attaching the temperature tag to an object, the temperature tag including one or more temperature sensitive regions on a substrate, wherein each of the one or more temperature sensitive regions include a temperature sensitive magnetic material having a Curie temperature; and reading the temperature tag after a period of time to determine if the object has been exposed to one or more temperatures that are higher than one or more Curie temperatures associated with the one or more temperature sensitive regions.

In some embodiments, a system for determining if an object has been exposed to one or more temperatures includes: at least one temperature tag that includes one or more temperature sensitive regions on a substrate, wherein each of the one or more temperature sensitive regions include a temperature sensitive magnetic material having a Curie temperature; and at least one magnetic field sensor configured to read the at least one temperature tag to determine if the object has been exposed to the one or more temperatures that are higher than one or more Curie temperatures associated with the one or more temperature sensitive regions.

In some embodiments, a method of making a temperature sensitive magnetic material includes: providing a mixture that includes at least one rare earth metal R, and one or more of Fe, B, N and Co, wherein R is Sc, Y, La, Ce, Pr, Nd, Pm, Sm, Eu, Gd, Tb, Dy, Ho, Er, Tm, Yb, Lu or any combination thereof; heating the mixture in an inert environment to form an alloy mixture; forming the alloy mixture into powder; press-molding the powder to form a compacted powder; sintering the compacted powder to form a sintered product; and magnetizing the sintered product to form the temperature sensitive magnetic material.

In some embodiments, a method of making a temperature sensitive magnetic material includes: providing a mixture that includes at least one carbonate ACO3, and an iron oxide (α-Fe₂O₃), wherein A is Ba, Sr, Ca, Pb, or any combination thereof; sintering the mixture in air to form a sintered mixture; forming the sintered mixture into powder; press-molding the powder to form a compacted powder; sintering the compacted powder to form a sintered product; and magnetizing the sintered product to form the temperature sensitive material.

### BRIEF DESCRIPTION OF THE DRAWINGS

FIG. 1 is a schematic illustration of a temperature tag having an array of temperature sensitive regions in accordance with some embodiments. The temperature tag exemplified in FIG. 1 has twelve temperature sensitive regions in the array and the temperature sensitive regions are labelled Tc1 to Tc12.

FIG. 2 illustrates an operation of a magnetic field sensor in accordance with some embodiments.

FIG. 3 is an exemplary graph showing magnetic flux density for each of the temperature sensitive regions Tc1 to Tc12 in the temperature tag of FIG. 1 after exposure to a temperature change.

FIG. 4 is a chart showing Curie temperatures of various rare earth magnetic alloys, and variations in the Curie temperatures with different rare earth elements.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

### Temperature Tags

Disclosed herein are temperature tags for detecting and storing a history of exposures of the tag, or an object to which the tag is attached, to one or more temperatures. The temperature tag described herein can include one or more temperature sensitive regions on a substrate, wherein each of the one or more temperature sensitive regions include a temperature sensitive magnetic material having a Curie temperature. The temperature tag can be configured to determine if the tag has been exposed to at least one temperature that is higher than the Curie temperature of the temperature sensitive magnetic material of at least one temperature sensitive region. The temperature tag can also be configured to determine if the tag has been exposed to two or more temperatures that are higher than the Curie temperatures of the temperature sensitive magnetic materials of two or more temperature sensitive regions.

The temperature sensitive magnetic material can have a magnetic property that changes after exposure to a temperature exceeding the Curie temperature, and the change in the magnetic property is not reversed when the temperature falls below the Curie temperature. In some embodiments, the magnetic property is magnetic flux density.

For example, when the object or tag is exposed to temperature changes, the magnetic flux density may decrease as the temperature approaches the Curie temperature and become almost negligible or zero as the temperature increases to above the Curie temperature. Thereafter, when the temperature drops to below the Curie temperature, the magnetic flux density does not return to its initial value. Therefore, a memory effect can be exhibited in the temperature sensitive magnetic material. The temperature tag can accordingly be configured to determine if the tag has been exposed to a temperature above a predetermined temperature by selecting a temperature sensitive magnetic material having a Curie temperature that is substantially similar to the predetermined temperature. If a plurality of different predetermined temperatures of exposure are desired to be detected, different temperature sensitive magnetic materials having different Curie temperatures can be selected to form the temperature sensitive regions of the temperature tag.

In some embodiments, the temperature sensitive magnetic material is a hard magnetic material. Hard magnetic materials are generally magnetic materials that have high coercivity, or are resistant to demagnetization. Examples of hard magnetic materials include ferrites, rare earth magnetic alloys that contain iron, and non-rare earth magnetic alloys that contain iron. In some embodiments, the temperature sensitive magnetic material includes ferrite, rare earth magnetic alloy, non-rare earth magnetic alloy or any combination thereof. In some embodiments, the non-rare earth magnetic alloy is Pt—Fe alloy, Pt—Co alloy, Fe—Co—Cr alloy or any combination thereof. In some embodiments, the ferrite is M-type ferrite, cobalt ferrite, titanium ferrite or any combination thereof. In some embodiments, the M-type ferrite is A-Fe₁₂O₁₉, wherein A is Ba, Sr, Ca, Pb or any combination thereof. In some embodiments, the rare earth magnetic alloy is one or more of R—Fe alloy, R—Fe—B alloy, R—Fe—N alloy and R—Co alloy, wherein R is one or more rare earth elements such as Sc, Y, La, Ce, Pr, Nd, Pm, Sm, Eu, Gd, Tb, Dy, Ho, Er, Tm, Yb, Lu or any combination thereof. In an embodiment, the R—Fe alloy is R₂Fe₁₇. In another embodiment, the R—Fe—B alloy is R₂Fe₁₄B.

The temperature sensitive magnetic material may include one or more additives. The one or more additives may include SiO₂, CaO, Bi₂O₃, H₃BO₃, Al₂O₃, MgO, or any combination thereof. Small amounts of additives, when added to an alloy mixture before sintering, can limit grain growth during the sintering which can improve coercivity (resistance to demagnetization) of the magnetic material.

In some embodiments, the one or more additives are present in the temperature sensitive magnetic material in an amount of about 0.1% to about 0.5% by weight. For example, the amount of additives present in the temperature sensitive magnetic material can be about 0.1%, about 0.2%, about 0.3%, about 0.4%, about 0.5% by weight, or an amount between any of these values.

The average particle size of the additives that are present in the temperature sensitive material can be in the nano-size range. In some embodiments, the average particle size of the additives is about 10 nm to about 50 nm. For example, the average particle size can be about 10 nm, about 15, nm, about 20 nm, about 25 nm, about 30 nm, about 35 nm, about 40 nm, about 45 nm, about 50 nm, or a particle size between any of these values. In some embodiments, the average particle size of the additives is about 10 nm to about 15 nm.

In some embodiments, the temperature sensitive magnetic material includes a M-ferrite made up of at least one carbonate ACO₃, wherein A is Ba, Sr, Ca or Pb, and an iron oxide. The iron oxide may for example be α-Fe₂O₃.

The one or more additives may be present in the temperature sensitive magnetic material in an amount of about 0.1% to about 0.5% by weight, including about 0.1%, about 0.2%, about 0.3%, about 0.4%, about 0.5% by weight, or an amount between any of these values. The at least one carbonate may be present in the temperature sensitive magnetic material in an amount of about 10% to about 25% by weight, including about 10%, about 15%, about 20%, about 25% by weight, or an amount between any of these values. The iron oxide may be present in the temperature sensitive magnetic material in an amount of about 74.5% to about 89.9% by weight, including about 74.5%, about 80%, about 85%, about 89.9% by weight, or an amount between any of these values.

Selection of the temperature sensitive magnetic material for each of the one or more temperature sensitive regions of the temperature tag can be dependent on one or more predetermined temperatures of exposure to be detected. The Curie temperature can vary for different temperature sensitive magnetic materials. Therefore, by selecting a temperature sensitive magnetic material with a Curie temperature that is substantially similar to the predetermined temperature of exposure to be detected, it is possible to configure the temperature tag to determine if the tag, or object to which the tag is attached, has been exposed to a temperature above the predetermined temperature.

In some embodiments, the Curie temperature of the temperature sensitive magnetic material is about −200° C. to about 1000° C. For example, the Curie temperature of the temperature sensitive magnetic material is about −200° C., about −100° C., about 0° C., about 100° C., about 200° C., about 300° C., about 400° C., about 500° C., about 600° C., about 700° C., about 800° C., about 900° C., about 1000° C., or a temperature between any of these values. In some embodiments, the Curie temperature of the temperature sensitive magnetic material is about 0° C. to about 100° C.

The Curie temperature of the temperature sensitive magnetic material can be dependent one or more of several factors as described below. The Curie temperature of the temperature sensitive magnetic material can be dependent on the type of metal components combined with iron oxide in ferrite based temperature sensitive magnetic materials. For example, different ferrites (for example, M-type ferrite, cobalt ferrite or titanium ferrite) can have different Curie temperatures. In the case of M-type ferrites (A-Fe₁₂O₁₉), varying the element A (for example, Ba, Sr, Ca or Pb) may result in different ferrites with different Curie temperatures. For ferrites formed from an alloy mixture of carbonate, iron oxide and additives, the Curie temperature of the temperature sensitive magnetic material can be dependent on a composition of the carbonate, composition of the additives, or both, in the temperature sensitive magnetic material. In general, the temperature range in which the Curie temperature for ferrites can be varied may be about 380° C. to about 480° C., depending on the composition of the ferrites.

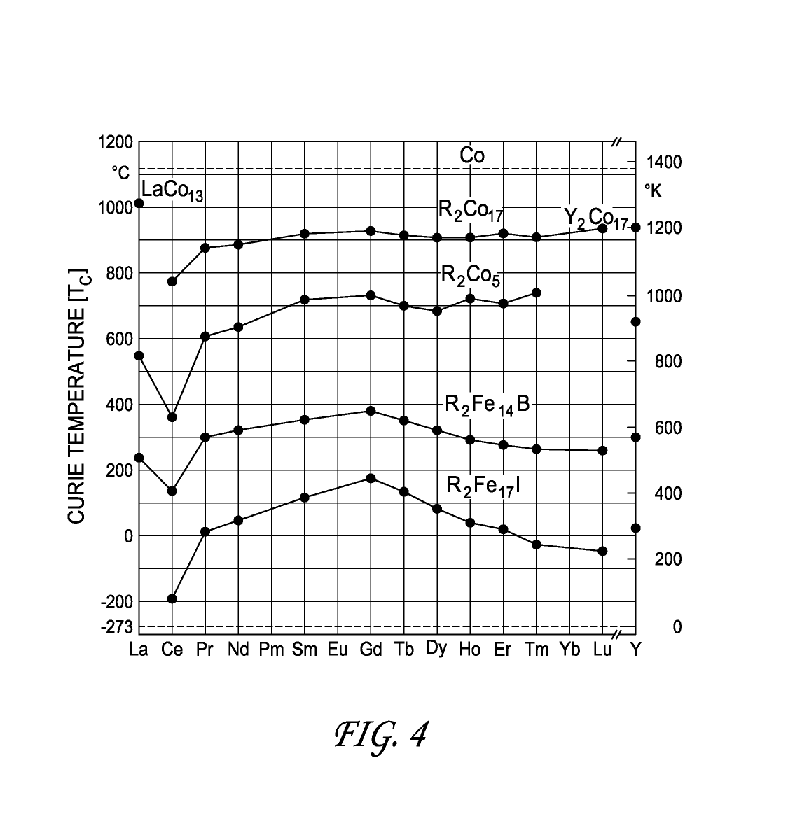

The Curie temperature of the temperature sensitive magnetic material can also be dependent on the type of rare-earth metal present in rare earth magnetic alloy based temperature sensitive magnetic materials. For example, different rare earth magnetic alloys (for example, R—Fe alloy, R—Fe—B alloy, R—Fe—N alloy or R—Co alloy) can have different Curie temperatures. Also, varying the rare earth element R (for example, Sc, Y, La, Ce, Pr, Nd, Pm, Sm, Eu, Gd, Tb, Dy, Ho, Er, Tm, Yb or Lu) may result in rare-earth magnetic alloys with different Curie temperatures. Referring to FIG. 4, the chart shows Curie temperatures of various rare earth magnetic alloys, and variations in the Curie temperatures with different rare earth elements in the alloys. For example, by varying R in the R₂Fe₁₇ alloy, the Curie temperature can be varied in the range of about −200° C. to about 200° C. Where the temperature tag is configured to detect temperature fluctuations occurring below 100° C., one can select R₂Fe₁₇ alloys with R as Ce, Pr, Nd, Dy, Ho, Er, Tm, Yb, Lu or Y. If the temperature fluctuation occurs at higher temperatures, other alloys may be selected as the temperature sensitive magnetic material for the temperature tag. For example, by varying R in the R₂Fe₁₄B alloy, the Curie temperature can be varied in the range of about 140° C. to about 400° C. By varying R in the RCo₅ alloy, the Curie temperature can be varied in the range of about 380° C. to about 740° C. By varying R in the RCo₅ alloy, the Curie temperature can be varied in the range of about 790° C. to about 920° C.

Various other factors can also determine the Curie temperature of the temperature sensitive magnetic material. The type of metal combined with iron, cobalt or both in non-rare earth magnetic alloy based temperature sensitive magnetic materials, and amount of additives present in the temperature sensitive magnetic material, can determine the Curie temperature of the temperature sensitive magnetic material. For example, different non-rare earth magnetic alloys such as Pt—Fe alloy, Pt—Co alloy or Fe—Co—Cr can have different Curie temperatures. Different amounts of additives can also form temperature sensitive magnetic materials with different Curie temperatures.

In some embodiments, the one or more temperature sensitive regions include a plurality of temperature sensitive regions. The plurality of temperature sensitive regions can include temperature sensitive magnetic materials having the same Curie temperature. In this case, all of the temperature sensitive regions may be configured to detect exposure of the tag or object to the same predetermined temperature. The plurality of temperature sensitive regions can alternatively include temperature sensitive magnetic materials having different Curie temperatures. In this case, the temperature sensitive regions may be configured to detect exposure of the tag or object to different predetermined temperatures.

The plurality of temperature sensitive regions can be arranged in an array on the substrate. For example, the plurality of temperature sensitive regions can be arranged in a two-dimensional array or in a linear array. The shape of the array is not limited and can for example be triangular shape or square shape. The number of temperature sensitive regions in the array can vary depending on the number of predetermined temperatures of exposure to be detected. The number of temperature sensitive regions on the temperature tag increases as the number of exposure temperatures to be detected increases. For example, if the tag is configured to detect exposures to temperatures of 10° C., 20° C., 30° C., 40° C. and 50° C. above room temperature, there can be at least five temperature sensitive regions in the array, each configured to detect a different temperature of exposure. In contrast, if the tag is configured to detect exposure to temperatures of 20° C. and 50° C. above room temperature, there can be at least two temperature sensitive regions. As described above, the temperature sensitive region can be configured to detect a predetermined temperature of exposure by selecting a temperature sensitive material having a Curie temperature that corresponds to the predetermined temperature of exposure. The predetermined temperatures of exposure as described herein are examples only, and can be other values depending on the sensitivity of a tagged object to temperature fluctuations.

The dimensions of the temperature sensitive region is not limited and can be dependent on the size of the tag. The temperature sensitive regions may have similar dimensions or may vary in dimensions. In some embodiments, at least one of the one or more temperature sensitive regions have a length of at least about 1 mm. For example, the length can be about 1 mm, about 5 mm, about 10 mm, about 15 mm, about 20 mm, or more.

In some embodiments, at least one of the one or more temperature sensitive regions have a width of at least about 0.5 mm. For example, the width can be about 0.5 mm, about 1 mm, about 2 mm, about 3 mm, about 4 mm, about 5 mm, or more.

In some embodiments, at least one of the one or more temperature sensitive regions have a thickness of at least about 0.1 mm. For example, the thickness can be about 0.1 mm, about 0.2 mm, about 0.4 mm, about 0.6 mm, about 0.8 mm, about 1 mm, or more.

In some embodiments, the temperature tag further includes a barrier layer on the one or more temperature sensitive regions. The barrier layer can, for example, protect the temperature sensitive regions from the environment such as moisture, oxygen and physical damage. The barrier layer may also secure the temperature sensitive regions on the substrate and prevent the temperature sensitive magnetic materials from delaminating from the substrate. In some embodiments, the barrier layer is nickel plating, gold plating, zinc plating, epoxy coating, polytetrafluoroethylene coating, or any combination thereof. In some embodiments, the barrier layer is TiN plating.

The magnetic property of the temperature sensitive magnetic material in each of the one or more temperature sensitive regions may be detected without physical contact via various forms of electromagnetic coupling. A contactless magnetic field sensor may be configured to detect the magnetic property to determine if the tag has been exposed to above or below one or more predetermined temperatures of interest.

### Methods of Making a Temperature Tag

A method of making a temperature tag may include forming one or more temperature sensitive regions on a substrate, wherein each of the one or more temperature sensitive regions includes a temperature sensitive magnetic material having a Curie temperature. In some embodiments, forming the one or more temperature sensitive regions includes depositing one or more temperature sensitive magnetic materials on the substrate.

The method may further include assigning one or more predetermined temperatures to the one or more temperature sensitive regions, and configuring the temperature sensitive magnetic material for each of the one or more temperature sensitive regions to have an irreversible change in magnetic property when exposed to a temperature above the predetermined temperature, before forming the one or more temperature sensitive regions on the substrate.

The assigning of the predetermined temperatures to the one or more temperature sensitive regions can be in any order. For example, the predetermined temperatures can be assigned to the temperature sensitive regions in an ascending order, in a descending order or in a random order from one end of the substrate to an opposite end of the substrate.

In some embodiments, the magnetic property is magnetic flux density. After the assigning step, the configuring of the temperature sensitive magnetic material may include selecting a temperature sensitive magnetic material having a Curie temperature that is substantially similar to the predetermined temperature assigned to the temperature sensitive region. The Curie temperature of the temperature sensitive magnetic material may for example be about −200° C. to about 1000° C. depending on the selection of the magnetic material as described above. The magnetic flux density of the temperature sensitive magnetic material may decrease as the temperature approaches the Curie temperature and become almost negligible or zero as the temperature increases to above the Curie temperature. The change in the magnetic flux density as a result of temperature changes is also irreversible, thereby enabling the temperature sensitive magnetic material to detect exposure of the tag or object to a temperature above the predetermined temperature. For example, where the tag or object is exposed to a temperature above the predetermined temperature (or Curie temperature) of a temperature sensitive region, the magnetic flux density detected for that temperature sensitive region will be negligible or zero, even if the temperature of the tag or object returns to room temperature.

In some embodiments, forming the one or more temperature sensitive regions includes forming a plurality of temperature sensitive regions. For example, after the assigning and the configuring steps, the selected temperature sensitive materials can be deposited on the substrate to form the one or more temperature sensitive regions. In some embodiments, forming the plurality of temperature sensitive regions includes depositing temperature sensitive magnetic materials having the same Curie temperature on the substrate (for example, where only one predetermined temperature of exposure is to be detected). In some embodiments, forming the plurality of temperature sensitive regions includes depositing temperature sensitive magnetic materials having different Curie temperatures on the substrate (for example, where different predetermined temperatures of exposure are to be detected).

In some embodiments, forming the plurality of temperature sensitive regions includes arranging the plurality of temperature sensitive regions in an array on the substrate. As described above, the plurality of temperature sensitive regions can be arranged in a two-dimensional array or in a linear array. The number of temperature sensitive regions in the array can vary depending on the number of predetermined temperatures of exposure to be detected.

The temperature sensitive magnetic material may be a hard magnetic material. In some embodiments, the temperature sensitive magnetic material includes ferrite, rare earth magnetic alloy, non-rare earth magnetic alloy or any combination thereof. In some embodiments, the non-rare earth magnetic alloy is Pt—Fe alloy, Pt—Co alloy, Fe—Co—Cr alloy or any combination thereof. In some embodiments, the ferrite is M-type ferrite, cobalt ferrite, titanium ferrite or any combination thereof. In some embodiments, the M-type ferrite is A-Fe₁₂O₁₉, wherein A is Ba, Sr, Ca or Pb. In some embodiments, the rare earth magnetic alloy is one or more of R—Fe alloy, R—Fe—B alloy, R—Fe—N alloy and R—Co alloy, wherein R is Sc, Y, La, Ce, Pr, Nd, Pm, Sm, Eu, Gd, Tb, Dy, Ho, Er, Tm, Yb, Lu or any combination thereof. In some embodiments, the R—Fe alloy is R₂Fe₁₇. In some embodiments, the R—Fe—B alloy is R₂Fe₁₄B. The temperature sensitive magnetic material may further include one or more additives as described above, for example, SiO₂, CaO, Bi₂O₃, H₃BO₃, Al₂O₃, MgO, or any combination thereof.

In some embodiments, the method further includes providing a barrier layer on the one or more temperature sensitive regions. The barrier layer may be any of the barrier layers described herein and can, for example, be nickel plating, gold plating, zinc plating, epoxy coating, polytetrafluoroethylene coating, or any combination thereof.

### System for Temperature Determination

Also disclosed herein is a system for determining if an object has been exposed to one or more temperatures. In some embodiments, the system includes: at least one temperature tag that includes one or more temperature sensitive regions on a substrate, wherein each of the one or more temperature sensitive regions include a temperature sensitive magnetic material having a Curie temperature; and at least one magnetic field sensor configured to read the at least one temperature tag to determine if the object has been exposed to the one or more temperatures that are higher than one or more Curie temperatures associated with the one or more temperature sensitive regions.

In some embodiments, the temperature sensitive magnetic material has a magnetic property that changes after exposure to a temperature exceeding the Curie temperature, and the change in the magnetic property is not reversed when the temperature falls below the Curie temperature. In some embodiments, the magnetic property is magnetic flux density.

In some embodiments, the temperature sensitive magnetic material is a hard magnetic material as described above. In some embodiments, the temperature sensitive magnetic material includes materials as described above, such as ferrite, rare earth magnetic alloy, non-rare earth magnetic alloy or any combination thereof.

The Curie temperature of the temperature sensitive magnetic material can vary. For example, the Curie temperature of the temperature sensitive magnetic material can be about −200° C. to about 1000° C., or as described above.

In some embodiments, the magnetic field sensor is configured to read the at least one temperature tag by detecting a change in magnetic property of the temperature sensitive magnetic material for each of the one or more temperature sensitive regions, wherein a detected change in one temperature sensitive region indicates exposure of the object to a temperature that is higher than the Curie temperature associated with that one temperature sensitive region. In some embodiments, the change in the magnetic property is a decrease in magnetic flux density.

In some embodiments, the magnetic field sensor is a Hall-effect sensor or a magneto-impedance sensor. In some embodiments, the temperature tag further includes a barrier layer as described above on the one or more temperature sensitive regions.

In some embodiments, the object is one or more of a food item, a personal care product, a pharmaceutical drug and an electronic device.

### Preparing a Temperature Sensitive Magnetic Material

Methods for making various temperature sensitive magnetic materials such as rare earth metal temperature sensitive magnetic materials and ferrite-based temperature sensitive magnetic materials are also disclosed herein. In some embodiments, a method of making a rare earth metal temperature sensitive magnetic material includes:
providing a mixture that includes at least one rare earth metal R, and one or more of Fe, B, N and Co, wherein R is Sc, Y, La, Ce, Pr, Nd, Pm, Sm, Eu, Gd, Tb, Dy, Ho, Er, Tm, Yb, Lu or any combination thereof;
heating the mixture in an inert environment to form an alloy mixture;
forming the alloy mixture into powder;
press-molding the powder to form a compacted powder;
sintering the compacted powder to form a sintered product; and
magnetizing the sintered product to form the temperature sensitive magnetic material.

The mixture can further include one or more additives as described above, such as SiO₂, CaO, Bi₂O₃, H₃BO₃, Al₂O₃, MgO, or any combination thereof.

The rare earth metal temperature sensitive magnetic material can include one or more hard magnetic materials, as described above. Non-limiting examples of the hard magnetic materials include R—Fe—B or R—Fe. In some embodiments, the rare earth metal temperature sensitive magnetic material is R₂Fe₁₄B. In some embodiments, the rare earth metal temperature sensitive magnetic material is R₂Fe₁₇.

In some embodiments, the heating of the mixture to form the alloy mixture can be carried out at temperatures above melting points of the components present in the mixture. The forming of the alloy mixture into powder can, in some embodiments, include grounding of the alloy mixture. In some embodiments, the grounding can be coarse grounding. In some embodiments, the grounding can be fine grounding. In some embodiments, the grounding can be coarse grounding followed by fine grounding. The resulting powder may have an average particle size that is in the micron range and in the nano range, for example, about 100 nm to about 10 μm.

In some embodiments, the method of making the rare earth metal temperature sensitive magnetic material further includes adjusting a Curie temperature of the rare earth metal temperature-sensitive magnetic material by varying the rare earth metal R in the mixture. As described above and in FIG. 4, varying the rare earth element R (for example, Sc, Y, La, Ce, Pr, Nd, Pm, Sm, Eu, Gd, Tb, Dy, Ho, Er, Tm, Yb or Lu) may result in rare-earth magnetic alloys with different Curie temperatures.

In some embodiments, the method of making the rare earth metal temperature sensitive magnetic material further includes adjusting a Curie temperature of the rare earth metal temperature-sensitive magnetic material by varying the amount of the additives in the mixture.

In some embodiments, press-molding the powder includes: providing the powder in a mold; and applying pressure to the powder in the presence of a magnetic field. The magnetic field can align the magnetic domains in the compacted powder so that anisotropic magnets, which have improved magnetic performance over non-aligned versions, can be created when the sintered product is magnetized in the later magnetizing step. The aligning of the magnetic domains can also facilitate the sintered product to be magnetized to saturation in the magnetizing step.

In some embodiments, sintering the compacted powder includes heating the compacted powder. The sintering can be carried at in an inert environment (oxygen free) such as in the presence of argon gas, nitrogen gas or other suitable inert gases. The sintering may occur at temperatures effective to cause densification of the compacted powder to form the sintered product, and can for example be at least about 700° C., about 700° C. to about 1200° C., about 900° C. to about 1200° C., or other suitable temperatures.

In some embodiments, the method of making the rare earth metal temperature sensitive magnetic material further includes cutting the sintered product into smaller pieces before magnetizing the sintered product. The size of the smaller pieces will be dependent on the desired size of the magnet in the final product.

In some embodiments, the method of making the rare earth metal temperature sensitive magnetic material further includes coating the sintered product with a barrier layer before magnetizing the sintered product. In some embodiments, the method of making the rare earth metal temperature sensitive magnetic material further includes coating the temperature sensitive magnetic material with a barrier layer after magnetizing the sintered product.

In some embodiments, magnetizing the sintered product includes exposing the sintered product to a magnetic field. The magnetic field can magnetize the sintered product (whose magnetic domains have been aligned in the press-molding step) to saturation to obtain maximum performance output of the magnet.

In some embodiments, a method of making a ferrite-based temperature sensitive magnetic material includes:
providing a mixture that includes at least one carbonate ACO₃, and an iron oxide (α-Fe₂O₃), wherein A is Ba, Sr, Ca, Pb, or any combination thereof;
sintering the mixture in air to form a sintered mixture;
forming the sintered mixture into powder;
press-molding the powder to form a compacted powder;
sintering the compacted powder to form a sintered product; and
magnetizing the sintered product to form the temperature sensitive material.

In some embodiments, the mixture further includes one or more additives as described above. For example, the one or more additives may include SiO₂, CaO, Bi₂O₃, H₃BO₃, Al₂O₃, MgO, or any combination thereof.

In some embodiments, the method of making the ferrite-based temperature sensitive magnetic material further includes adjusting a Curie temperature of the temperature sensitive magnetic material by varying an amount of ACO₃ in the mixture, varying an amount of iron oxide (α-Fe₂O₃) in the mixture, varying an amount of the additives in the mixture, or any combination thereof.

In some embodiments, the ferrite-based temperature sensitive magnetic material is a hard magnetic material as described above.

The sintering of the mixture in air may be carried out at temperatures effective for the components in the mixture to form metallic oxides, and may for example be at least about 700° C., about 700° C. to about 1400° C., about 1000° C. to about 1400° C., or other suitable temperatures. The forming of the sintered mixture into powder can, in some embodiments, include grounding of the sintered mixture. In some embodiments, the grounding can be coarse grounding. In some embodiments, the grounding can be fine grounding. In some embodiments, the grounding can be coarse grounding followed by fine grounding. The resulting powder may have an average particle size that is in the micron range, for example, about 10 μm to about 900 μm.

In some embodiments, the press-molding of the powder includes providing the powder in a mold; and applying pressure to the powder in the presence of a magnetic field. The magnetic field can align the magnetic domains in the compacted powder so that anisotropic magnets, which have improved magnetic performance over non-aligned versions, can be created when the sintered product is magnetized in the later magnetizing step. The aligning of the magnetic domains can also facilitate the sintered product to be magnetized to saturation in the magnetizing step.

In some embodiments, sintering the compacted powder includes heating the compacted powder. The compacted powder may be sintered at temperatures effective to result in densification of the compacted powder to form the sintered product, and can for example be at least about 1000° C., about 1000° C. to about 1300° C., about 1100° C. to about 1300° C., or other suitable temperatures.

In some embodiments, the method of making the temperature sensitive magnetic material further includes cutting the sintered product into smaller pieces before magnetizing the sintered product. The size of the smaller pieces will be dependent on the desired size of the magnet in the final product.

In some embodiments, the method of making the temperature sensitive magnetic material further includes coating the sintered product with a barrier layer before magnetizing the sintered product.

In some embodiments, the method of making the temperature sensitive magnetic material further includes coating the temperature sensitive magnetic material with a barrier layer after magnetizing the sintered product.

In some embodiments, magnetizing the sintered product includes exposing the sintered product to a magnetic field. The magnetic field can magnetize the sintered product (whose magnetic domains have been aligned in the press-molding step) to saturation to obtain maximum performance output of the magnet.

### Methods of Using a Temperature Tag

A method of using a temperature tag may include attaching the temperature tag to an object, the temperature tag including one or more temperature sensitive regions on a substrate, wherein each of the one or more temperature sensitive regions comprise a temperature sensitive magnetic material having a Curie temperature; and reading the temperature tag after a period of time to determine if the object has been exposed to one or more temperatures that are higher than one or more Curie temperatures associated with the one or more temperature sensitive regions. In some embodiments, the object is one or more of a food item, a personal care product, a pharmaceutical drug and an electronic device.

In some embodiments, reading the temperature tag includes detecting a change in magnetic property of the temperature sensitive magnetic material for each of the one or more temperature sensitive regions, wherein a detected change in one temperature sensitive region indicates exposure of the object to a temperature that is higher than the Curie temperature associated with that one temperature sensitive region. The change in the magnetic property can be a decrease in magnetic flux density.

In some embodiments, the method of detecting a temperature history of an object can include attaching the temperature tag described herein to a RFID tag and forwarding the temperature history information to a data receiver.

The magnetic properties of the temperature sensitive magnetic material for each of the temperature sensitive regions may be detected, either directly or indirectly, using an appropriate sensor. In some embodiments, the change in magnetic property is detected using a magnetic field sensor. The magnetic field sensor can for example be a Hall-effect sensor or a magneto-impedance sensor.

In some embodiments, the measured magnetic property is magnetic susceptibility, the detector is configured to measure a change in the magnetic property. In this case, the detector can be a Hall effect sensor, which produces an output electrical signal, such as a voltage, which is dependent upon the strength of a surrounding magnetic field.

The temperature tag can be read at multiple points: upon arrival at the first origin station, which can be the place where the tag is attached, when the object leaves that station and is transferred to a shipping service, when the object is received at the destination station located nearest the intended recipient, and when it is shipped from that site to the intended recipient. At each of these reading stations, the history of exposures to predetermined temperatures can be read using a magnetic field detector as described above and the temperature exposure history information can be forwarded via a wireless connection to a receiver, where the data is interpreted and stored.

The temperature tag may also be coupled with a signal element that interacts with the interrogation field to produce a remotely readable magnetic response. The temperature tag can interact magnetically with the signal element such that the remotely readable magnetic response is indicative of a temperature in the operating range. Advantageously, this temperature-dependent magnetic response is an intrinsic function of the materials and structure of the tag, and thus requires no electronic circuitry on the tag. This can results in significant cost reduction in making and using the tags.

### Examples

### Example 1

### Preparation of Ferrite Based Temperature Sensitive Material

This Example describes an exemplary method of forming ferrite based temperature sensitive materials.

A carbonate of Ba or Sr (BaCO₃ or SrCO₃), iron oxide (α-Fe₂O₃), and trace amounts of additives (SiO₂, CaO, Bi₂O₃, H₃BO₃, Al₂O₃ and/or MgO) are mixed to form a mixture, followed by sintering the mixture at about 1000° C. to about 1350° C. in air to form a sintered mixture. The sintered mixture is formed into powder having an average particle size in the micron range (for example, about 10 μm to about 100 μm), and the powder is press-molded to form a compacted powder. The compacted powder is sintered at about 1100° C. to about 1300° C. to form a sintered product, which is magnetized to form the temperature sensitive material.

In order to form materials with different Curie temperatures, the amount of carbonate and the amount of additives present in the mixture is varied. The amount of carbonate and/or additives required to form a material with a desired Curie temperature can be determined by routine trial and error. The Curie temperatures for the ferrite based temperature sensitive material as described in this Example is expected to vary over a range of about 380° C. to 480° C.

### Example 2

### Preparation of Rare Earth Metal Based Temperature Sensitive Magnetic Material

This Example describes an exemplary method of forming rare earth metal based temperature sensitive materials.

At least one rare earth metal (Sc, Y, La, Ce, Pr, Nd, Pm, Sm, Eu, Gd, Tb, Dy, Ho, Er, Tm, Yb, and/or Lu) and one or more of Fe, B, N and Co are mixed to form a mixture, followed by heating the mixture in an inert environment (argon gas or nitrogen gas) to above melting points of the components in the mixture to form an alloy mixture. The alloy mixture is formed into powder having an average particle size in the few micron range (for example, about 1 μm to about 5 μm), and the powder is press-molded to form a compacted powder. The compacted powder is sintered at about 900° C. to about 1200° C. to form a sintered product, which is magnetized to form the temperature sensitive material.

In order to form materials with different Curie temperatures, the type of rare-earth metal present in the temperature sensitive magnetic material is varied. Referring to FIG. 4, the chart shows variations in the Curie temperatures of various rare earth based temperature sensitive magnetic materials with different rare earth elements.

By varying R in the R₂Fe₁₇ alloy, the Curie temperature can be designed to be in the range of about −200° C. to about 200° C. Therefore, is the temperature tag is configured to detect temperature fluctuations occurring below 100° C., one can select R₂Fe₁₇ alloys with R as Ce, Pr, Nd, Dy, Ho, Er, Tm, Yb, Lu or Y. If the temperature fluctuation to be detected occurs at higher temperatures, other alloys may be selected as the temperature sensitive magnetic material for the temperature tag. By varying R in the R₂Fe₁₄B alloy, the Curie temperature can be designed to be in the range of about 140° C. to about 400° C. By varying R in the RCo₅ alloy, the Curie temperature can be designed to be in the range of about 380° C. to about 740° C. By varying R in the RCo₅ alloy, the Curie temperature can be designed to be in the range of about 790° C. to about 920° C.

### Example 3

### Preparation and Use of Temperature Tag

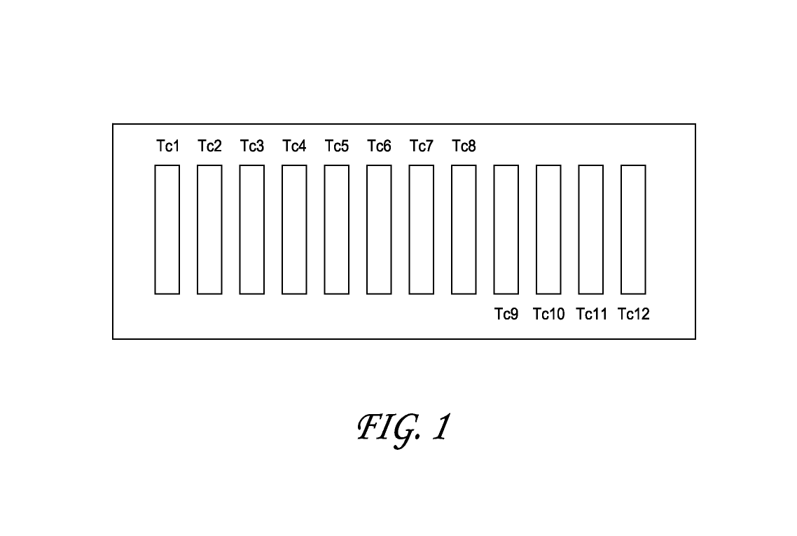

FIG. 1 schematically shows an example of a temperature tag produced by forming an array of temperature sensitive regions on a substrate. The temperature sensitive regions are arranged in a linear array such that the Curie temperatures of the temperature sensitive magnetic materials of the respective regions gradually decreases from the left to the right in the order Tc1, Tc2, Tc3, Tc4, Tc5, Tc6, Tc7, Tc8, Tc9, Tc10, Tc11, and Tc12. The size of each hard magnetic material is about 1 mm in width and 5 mm in length, and the size of the tag is about 20 mm by 8 mm. The temperature sensitive magnetic materials can be prepared from the method as described in Examples 1 or 2.

When using the tag, the tag is attached to a packaging that contains a pharmaceutical drug. When the packaged drug has been collected from a warehouse, a change in magnetic flux is read by means of a magnetic field sensor, such as a Hall element or a magnetic impedance element, which makes it possible to ascertain the highest temperature that the tag or the pharmaceutical drug has been exposed to.

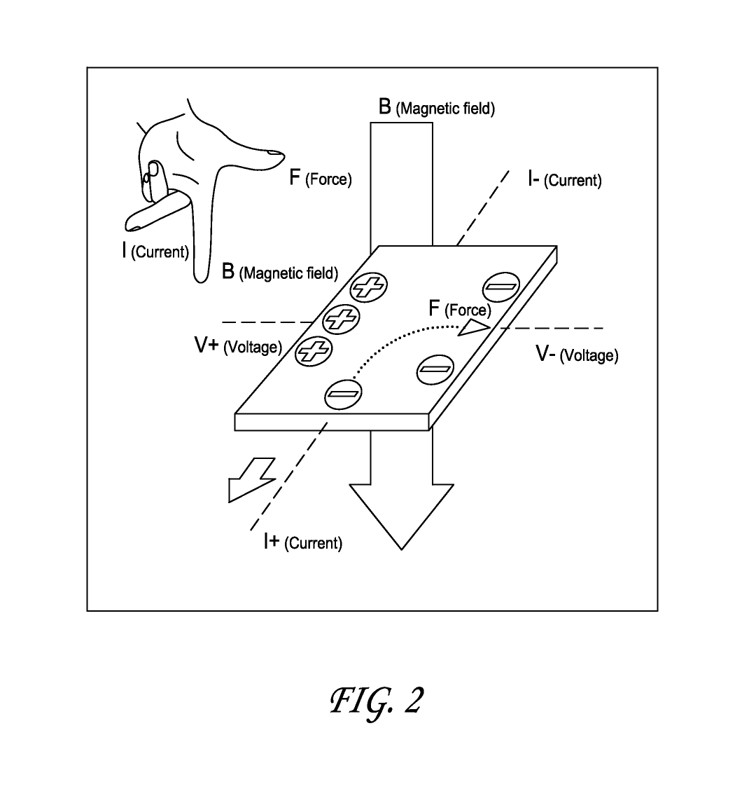

FIG. 2 illustrates how a magnetic sensor using a Hall element operates, when charged particles move in a magnetic field, that is, when there is a current, the charged particles moving in a conductor receive a force caused by the Lorentz force. Because of this force, the charged particles are biased in the direction of the force. That is, an electric field is generated in a direction perpendicular to the current. As a result, a voltage occurs across both ends. It is possible to readily calculate the magnetic field (magnetic flux density) from this voltage.

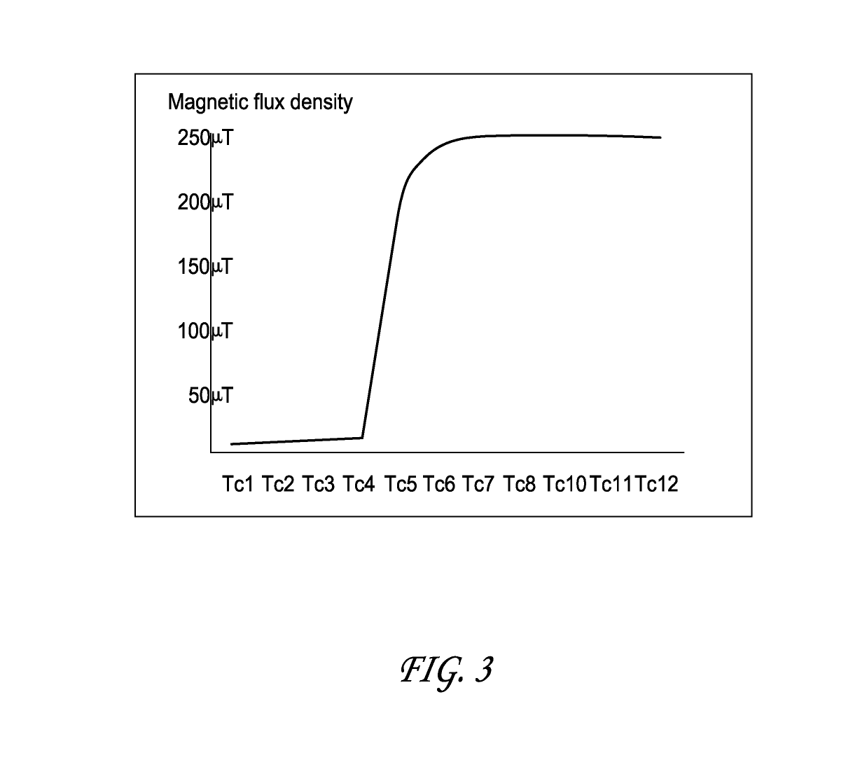

FIG. 3 is an overview of an exemplary measurement result for the temperature tag by means of a magnetic sensor. For a hard magnetic material, the magnetic flux density suddenly decreases from the vicinity of the Curie temperature, and magnetic flux becomes almost absent above the Curie temperature. Even if the temperature then drops below the Curie temperature, the value of magnetic flux density does not return to the initial value. Therefore, based on the change of magnetic flux density of the hard magnetic materials in the temperature tag, it can be determined that the temperature tag has been exposed to temperatures as high as Tc5.

The Examples above demonstrate that temperature tags capable of detecting temperature changes without the use of a continuous power source or additional electronic circuitry can be prepared and used to detect exposure of products to temperature fluctuations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” and so on). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases at least one and one or more to introduce claim recitations. However, the use of such phrases should not be construed to imply that the introduction of a claim recitation by the indefinite articles “a” or an limits any particular claim containing such introduced claim recitation to embodiments containing only one such recitation, even when the same claim includes the introductory phrases one or more or at least one and indefinite articles such as “a” or an (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, and so on” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, and so on). In those instances where a convention analogous to “at least one of A, B, or C, and so on” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, and so on). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, and so on. As a non-limiting example, each range discussed herein can be readily broken down into a lower third, middle third and upper third, and so on. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A temperature tag comprising:
one or more temperature sensitive regions on a substrate,
wherein each of the one or more temperature sensitive regions comprise a temperature sensitive magnetic material having a Curie temperature.

2. The temperature tag of claim 1, wherein the temperature sensitive magnetic material has a magnetic property that changes after exposure to a temperature exceeding the Curie temperature, and the change in the magnetic property is not reversed when the temperature falls below the Curie temperature; and wherein the magnetic property is magnetic flux density.

3. The temperature tag of claim 1, wherein the temperature sensitive magnetic material comprises ferrite, rare earth magnetic alloy, non-rare earth magnetic alloy or any combination thereof.

4. The temperature tag of claim 1, wherein the temperature sensitive magnetic material comprises non-rare earth magnetic alloy, and the non-rare earth magnetic alloy is Pt—Fe alloy, Pt—Co alloy, Fe—Co—Cr alloy or any combination thereof.

5. The temperature tag of claim 1, wherein the temperature sensitive magnetic material comprises ferrite, and the ferrite is M-type ferrite, cobalt ferrite, titanium ferrite or any combination thereof.

6. The temperature tag of claim 1, wherein the temperature sensitive magnetic material comprises rare earth magnetic alloy, and the rare earth magnetic alloy is one or more of R—Fe alloy, R—Fe—B alloy, R—Fe—N alloy and R—Co alloy, wherein R is Sc, Y, La, Ce, Pr, Nd, Pm, Sm, Eu, Gd, Tb, Dy, Ho, Er, Tm, Yb, Lu or any combination thereof.

7. The temperature tag of claim 1, wherein the temperature sensitive magnetic material comprises one or more additives, the one or more additives comprising SiO₂, CaO, Bi₂O₃, H₃BO₃, Al₂O₃, MgO, or any combination thereof.

8. The temperature tag of claim 1, wherein the temperature sensitive magnetic material comprises:
at least one carbonate ACO₃, wherein A is Ba, Sr, Ca or Pb; and
an iron oxide.

9. The temperature tag of claim 1, wherein the Curie temperature of the temperature sensitive magnetic material is about −200° C. to about 1000° C.

10. The temperature tag of claim 1, further comprising a barrier layer on the one or more temperature sensitive regions.

11. The temperature tag of claim 10, wherein the barrier layer is nickel plating, gold plating, zinc plating, epoxy coating, polytetrafluoroethylene coating, or any combination thereof.

12. A method of making a temperature tag, the method comprising
forming one or more temperature sensitive regions on a substrate, wherein each of the one or more temperature sensitive regions comprise a temperature sensitive magnetic material having a Curie temperature.

13. The method of claim 12, further comprising:
assigning one or more predetermined temperatures to the one or more temperature sensitive regions; and
configuring the temperature sensitive magnetic material for each of the one or more temperature sensitive regions to have an irreversible change in magnetic property when exposed to a temperature above the predetermined temperature, before forming the one or more temperature sensitive regions on the substrate.

14. The method of claim 13, wherein the magnetic property is magnetic flux density.

15. The method of claim 13, wherein configuring the temperature sensitive magnetic material comprises:
selecting a temperature sensitive magnetic material having a Curie temperature that is substantially similar to the predetermined temperature assigned to the temperature sensitive region.

16. The method of claim 12, wherein the temperature sensitive magnetic material comprises ferrite, rare earth magnetic alloy, non-rare earth magnetic alloy or any combination thereof.

17. The method of claim 12, wherein the temperature sensitive magnetic material comprises non-rare-earth magnetic alloy, and the non-rare earth magnetic alloy is Pt—Fe alloy, Pt—Co alloy, Fe—Co—Cr alloy or any combination thereof.

18. The method of claim 12, wherein the temperature sensitive magnetic material comprises ferrite, and the ferrite is M-type ferrite, cobalt ferrite, titanium ferrite or any combination thereof.

19. The method of claim 12, wherein the temperature sensitive magnetic material comprises one or more additives, the one or more additives comprising SiO₂, CaO, Bi₂O₃, H₃BO₃, Al₂O₃, MgO, or any combination thereof.

20. The method of claim 12, wherein the Curie temperature of the temperature sensitive magnetic material is about −200° C. to about 1000° C.

21. The method of claim 12, further comprising providing a barrier layer on the one or more temperature sensitive regions.

22. A method of using a temperature tag, the method comprising:
attaching the temperature tag to an object, the temperature tag comprising one or more temperature sensitive regions on a substrate, wherein each of the one or more temperature sensitive regions comprise a temperature sensitive magnetic material having a Curie temperature; and
reading the temperature tag after a period of time to determine if the object has been exposed to one or more temperatures that are higher than one or more Curie temperatures associated with the one or more temperature sensitive regions.

23. The method of claim 22, wherein reading the temperature tag comprises:
detecting a change in magnetic property of the temperature sensitive magnetic material for each of the one or more temperature sensitive regions, wherein a detected change in one temperature sensitive region indicates exposure of the object to a temperature that is higher than the Curie temperature associated with that one temperature sensitive region.

24. The method of claim 23, wherein the change in the magnetic property is a decrease in magnetic flux density.

25. The method of claim 22, wherein the change in magnetic property is detected using a magnetic field sensor.

26. The method of claim 25, wherein the magnetic field sensor is a Hall-effect sensor or a magneto-impedance sensor.

27. The method of claim 22, wherein the object is one or more of a food item, a personal care product, a pharmaceutical drug and an electronic device.
